(19) United States
(12) Patent Application Publication
(10) Pub. No.: US 2014/0083031 A1
(43) Pub. Date: Mar. 27, 2014

(54) VOID FORMER AND METHOD OF REINFORCING

(71) Applicant: Ronald Lindsay Dunlop, Auckland (NZ)

(72) Inventor: Ronald Lindsay Dunlop, Auckland (NZ)

(21) Appl. No.: 13/974,428

(22) Filed: Aug. 23, 2013

(30) Foreign Application Priority Data
Aug. 24, 2012 (NZ) 602038

(51) Int. Cl. B28B 21/62; E04C 5/16; E04C 5/08

(52) U.S. Cl. CPC B28B 21/62; E04C 5/08; E04C 5/16
USPC 52/223.14; 249/97; 52/742.14

(57) ABSTRACT

A void former for forming a void in a concrete element is described. The void is adapted to receive at least one pliant reinforcing member. The void former is shaped or configured so that the void formed by said void former comprises an aperture in a surface of the concrete element for a said pliant reinforcing member to at least enter the void, and an internal surface shaped to direct the pliant reinforcing member through the void and back towards the surface of the concrete element to exit the void at the surface of the concrete element at a distance away from a portion of the pliant reinforcing member entering the void. A concrete element comprising a void, and a structure or building comprising a concrete element, and a method of reinforcing a concrete element or a building or structure is also described.

### TECHNICAL FIELD

The present invention relates to a void former for forming a void in a concrete element, a concrete element comprising a void, and a structure or building comprising a concrete element with a void and a pliable reinforcing member extending through the void, and a method of reinforcing a concrete element or a building or structure.

Throughout this specification, the term concrete has been used as a reference to any or all cementitious materials and should be so interpreted.

### BACKGROUND OF THE INVENTION

For builders in many countries it has become common practice to use precast concrete elements to speed up construction and improve the quality of the finished structure.

The precasting process involves pouring concrete in a factory to the shapes desired, and when the element is hard, sending them to site for installation. Once on site the element is incorporated into the structure by pouring concrete around steel starter bars protruding from the precast concrete. But as will be seen there are a number of problems with this starter bar connection methodology.

When a wall element is handled it is important to prevent the starter bars hitting other objects and causing damage to factory equipment or staff. For these reasons they are bent flat against the face of the element. This task requires muscle power and takes up valuable time in the precast factory and also on site, because the site workers must bend them straight again.

A complicating issue for designers is the grade of steel used in the starter bar. The use of 500 MPa grade steel is desirable but it is undesirable to re-bend this steel. Re-bending causes a reduction in the ultimate load capacity so 300 MPa may be used, as it can be re-bent. But by using this weaker steel the designer needs to increase the number of starter bars at the joint, which causes an increase in material and labour costs.

For a wall element the purpose of the starter bar is to give mechanical leverage when structural forces act on the wall. They are held in place not only by the concrete but also shear bars that the starter bars are bent around. Usually when a starter bar is loaded the concrete surrounding the bar will break before the bar does, but it will not move due to the actions of the shear bar. In wall panels the starter bars are embedded at about half the walls thickness, which is less than desirable. Therefore the wall has a higher capacity available for the structural forces than is being used and is not an efficient use of the wall or element.

Wall panels cast on site are often produced using stack-casting methodologies. This is where one element is poured on top the other. It is not possible to have starter bars protruding from a lower panel. So threaded inserts are cast in which to fit threaded reinforcing rods. However this kind of connection is not as strong due to the thread being cut into the rod. It is also less desirable as the insert acts in a brittle way inside the concrete, and is affected when the concrete cracks allowing the insert to slip prematurely.

When the designer is using prestressed flooring systems supported on beams, they are faced with the difficulty of connecting them together. It is possible for the beam starters to be bent away to allow the element into the structure being constructed, for example between two upright columns or walls. But it is almost impossible to bend them back and make them lie flat into the topping concrete because there is too little room to work above the installed flooring element. Therefore precasting options are replaced by using more on-site construction.

On larger structures the designer may still prefer to use larger diameter starter bars in the precast. As a result they may be forced to weld or swage reinforcing onto these short protruding bars. But this can be difficult for a number of reasons so more site pouring is used as an alternative. This is slower than precasting and as a result there has been a trade off, and the speed of construction suffers and costs may increase.

The use of void formers in building structures is known, especially for concrete structures; see New Zealand patent specification number 330593. The void former of NZ 330593 allows a rigid U shaped reinforcing member to be introduced into a concrete element after the concrete element has been cast. These have been shown to provide several advantages in terms of the strength to weight ratio of structures made with a void former. However, void formers at present do little, if anything, to increase the strength of the structure between separate members.

The use of cables for reinforcement is known in building elements but currently they are used for stressed concrete where the cables are stressed either before or after pouring the element concrete. Such structures may include bridge beams and long floor elements. Cables are not used as starter bars in elements as their holding capacity is related to having very long lengths of embedment into the concrete. These cables are wound using one group of wires and are too rigid to be easily bent by a user.

It is an object of the present invention to overcome or at least alleviate one or more of the above mentioned problems in reinforcing building structures, or at least to provide the public or building and construction industry with a useful choice.

### SUMMARY OF THE INVENTION

In one aspect, the present invention consists in a void former for forming a void in a concrete element for receiving at least one pliant reinforcing member, the void former shaped or configured so that the void formed by said void former comprises:

an aperture in a surface of the concrete element for a said pliant reinforcing member to enter the void,

an internal surface for directing the pliant reinforcing member through the void and back towards the surface of the concrete element to exit the void at the surface of the concrete element and at a distance away from a portion of the pliant reinforcing member entering the void.

Preferably the void former is in the shape of an arc or “U”.

Preferably the aperture is an entrance aperture in the surface of the concrete element and the void former is shaped or configured so that the void formed by the void former comprises an exit aperture in the surface of the concrete element for the pliant reinforcing member to exit the void, and a tube-like conduit extending between the entrance aperture and the exit aperture.

Preferably the internal surface is shaped to facilitate insertion of the pliant reinforcing member through the void by having a shape that directs the pliant reinforcing member through an obtuse angle relative to a central portion of the void.

Preferably the void former is shaped so that the cross sectional area of the void increases towards the entrance and exit apertures from a central portion of the void.

Preferably the internal surface is commensurate with the flexibility of the pliant reinforcing member so as to allow the pliant reinforcing member to be pushed or threaded through the void by a user pushing the pliant reinforcing member along a longitudinal axis of the pliant reinforcing member into the void via the entrance aperture so that contact between the pliant reinforcing member and the internal concave surface bends the pliant reinforcing member through the void and back towards the surface of the concrete element.

In one embodiment the void former comprises an elongate serration or a plurality of elongate serrations on the surface of the void former to protrude into the surrounding concrete of the concrete element,.

Preferably the void former comprises a plurality of sloping surfaces on the void former to protrude into the surrounding concrete of the concrete element, the sloping surfaces at an angle to the surface of the concrete element.

Optionally the void former comprises an elongate extension member or members to set a depth of the void former below the surface of the concrete element, the extension member or members for forming a portion or portions of the void in the concrete element.

Preferably the void former comprises one or more protrusions or legs extending from the exterior surface of the void former, the protrusions or legs being adapted to raise the void former from an opposite surface of the concrete element so that the void former can be substantially surrounded by the concrete of the concrete element.

Preferably the void former comprises one or a plurality of pipes protruding from the surface of said void former or one or a plurality of protrusions protruding from the surface of said void former, each protrusion for attaching a pipe, said pipe or pipes adapted to extend to above the surface of the concrete element so that appropriate materials can flow through the pipes to fill the void.

Preferably the void former comprises at least one cover for covering an entrance receptacle and/or an exit receptacle of the void former, to prevent materials falling into the void and impeding entry of the pliant reinforcing member.

Preferably the void former comprises a removable weight for reducing buoyancy of the void former in wet concrete, the removable weight positioned to in use be adjacent an entrance or exit aperture of the void.

Preferably the void former comprises a plurality of interlocking parts.

Preferably the void former comprises an entrance part, an exit part, and a spacer between the entrance and exit parts, the length of the spacer predetermined for a desired loading capacity of the pliant reinforcing member.

Preferably the void former is constructed to remain or at least remain partially in the concrete element after the concrete element has set.

Preferably the void former comprises a hollow member or assembly for receiving the pliant reinforcing member, the interior of the hollow member forming the void in the concrete element.

Alternatively or additionally the void former comprises a body formed of a material adapted to be dissolved, melted or otherwise destroyed after the concrete of the concrete element has set to create the void.

Preferably the void former or any component making up the void former is made from one or a combination of polystyrene, plastic, steel, or aluminium materials.

Alternatively the void former comprises a collapsible bag or membrane, the bag or membrane adapted to be deflated to be removed from the concrete element to form the void when the concrete element has set.

Preferably the aperture is an entrance aperture in the surface of the concrete element and the void former is shaped or configured so that the void formed by said void former comprises an exit aperture in the surface of the concrete element for the pliant reinforcing member to exit the void, and the void former is removable via the entrance aperture or the exit aperture.

The void former may be adapted to be positioned below the surface of the concrete element so that, after the concrete element has set, concrete between the surface of the concrete element and the void former can be broken to create the entrance aperture or the entrance aperture and an exit aperture.

Preferably the void is adapted to be filled with a substance to hold and/or protect the pliant reinforcing member or members. Preferably the void-filling substance is a cementitous material.

Preferably is adapted to be held in an engaging arrangement against at least a further reinforcing member on or near an exterior surface of the void former.

Preferably comprises a further reinforcing member locating means adapted to position the further reinforcing member on or near an exterior surface of the void former.

Preferably the further reinforcing member locating means comprises one or more markings, raised portions, recessed portions, hooks, clips, or an aperture on or near an exterior surface of the void former.

Preferably the void former is adapted to position the or each further reinforcing member to be embedded in the concrete element and to engage the pliant reinforcing member or members.

Preferably the further reinforcing member is steel reinforcing.

Preferably the void former comprises a hollow member or assembly for receiving the plant reinforcing member, the interior of the hollow member forming the void in the concrete element, and including at least one pliant reinforcing member extending into the void former to in use have at least one end portion of said pliant reinforcing member protruding a distance from the surface of the concrete element.

Preferably the void former comprises an entrance receptacle and an exit receptacle and the pliant reinforcing member enters the void former via the entrance receptacle and exits the void former via the exit receptacle, and after exiting the void former via the exit receptacle the pliant reinforcing member is directed at least once through the entrance receptacle to form at least one loop extending out of the void former to in use protrude a distance from the surface of the concrete element, the entrance receptacle of the void former providing an entrance aperture in the surface of the concrete element for the pliant reinforcing member to enter the void and the exit receptacle of the void former forming an exit aperture in the surface of the concrete element for the pliant reinforcing member to exit the void.

Preferably the internal surface of the void comprises a curved concave surface.

Preferably the void former is shaped or configured so that the internal concave surface of the void comprises a first curved surface and a second curved surface facing the first curved surface and spaced from the first curved surface by a connecting surface.

Preferably the pliant reinforcing member comprises a multiple strand cable, each strand comprising a plurality of steel wires.

In another aspect the present invention consists in a method of reinforcing a concrete structure comprising:

providing a void former for forming a void in a concrete element with an entrance aperture in a surface of the concrete element, setting concrete around the void former to form a precast concrete element comprising the void; the void former shaped or configured so that the void formed by said void former comprises the entrance aperture in the surface of the concrete element for a pliant reinforcing member to enter the void, and an internal surface shaped to direct the pliant reinforcing member through the void and back towards the surface of the concrete element to exit the void at the surface of the concrete element and at a distance away from a portion of the pliant reinforcing member entering the void;

inserting a pliant reinforcing member into the void so that at least one end portion of the pliant reinforcing member protrudes from the surface;

anchoring at least one end portion of the pliant reinforcing member in the concrete structure.

Preferably the method comprises:

threading the pliant reinforcing member through more than one said void in the concrete element, each void formed by a said void former, and anchoring at least one end portion and a portion of the pliant reinforcing member extending between voids in the concrete structure.

Preferably the method comprises turning the pliant reinforcing member at least once back through the entrance aperture to re-enter the void so that the pliant reinforcing member forms a loop, a portion of the loop extending beyond the surface of the concrete element, and anchoring the portion of the loop in the concrete structure.

Preferably the aperture is an entrance aperture in the surface of the concrete element and the void comprises an exit aperture in the surface of the concrete element for the pliant reinforcing member to exit the void, and a tube like conduit extending between the entrance aperture and the exit aperture.

Preferably the method comprises providing a void former with a further reinforcing member locating means comprising at least one surface markings, raised portions, recessed portions, hooks, clips, or an aperture on or near an exterior surface, and engaging one or more further reinforcing members with the locating means before setting concrete around said void former.

The method may comprise tying the void former to the or each further reinforcing member.

Preferably the method comprises providing the or each further reinforcing member and embedding the or each further reinforcing member in the precast concrete element to resist movement of the inserted pliant reinforcing member in the concrete when loaded.

Preferably the method comprises providing a suitable void filling material installed through pipes protruding from the void former and extending beyond the surface of the concrete element to hold and protect the pliant reinforcing member when in use.

Preferably the method comprises providing serrations and or sloping surfaces to the void former surface to hold more securely the loaded pliant reinforcing member and void filling material inside the concrete element.

Preferably the method comprises positioning the void former on at least one protrusion or leg when forming the concrete element so that the void former is positioned to be substantially surrounded by the concrete of the concrete element.

Preferably the method comprises providing an end cap or other friction reducing means on the end portion of the pliant reinforcing member adapted to assist the member's movement through the void.

In one embodiment the method comprises anchoring at least one end portion of the pliant reinforcing member in a second precast concrete element in which at least one elongate hollow chamber is formed for receiving an end portion of the pliant reinforcing member bringing the precast elements together, filling the elongate hollow chamber and the void with concrete to embed the pliant reinforcing member therein.

In one embodiment the method comprises positioning the precast element adjacent to a second precast element, each precast element having at least one void formed by a said void former, leaving a space between the two precast elements, extending the pliant reinforcing member through the void of each precast element to form at least one loop through said void formers. Optionally the pliant reinforcing member forms at least one figure-of-eight loop. Preferably end portions of the pliant reinforcing member are clamped to a section of the p ant reinforcing member within the space between the two precast elements so that movement of the pliant reinforcing member is restricted or prevented when under a load. Preferably the space between the two precast elements is filled with concrete to embed the pliant reinforcing member.

The voids may be filled with concrete after the space between the two precast elements is filled with concrete to embed the pliant reinforcing member. Preferably the pliant reinforcing member is not strained to cause elastic elongation of the pliant reinforcing member.

In one embodiment the method comprises providing or connecting an extension to the void former to set a depth of the void former below the surface of the concrete element, the extension forming a portion of the void in the concrete element.

Preferably the void former is a hollow member or assembly providing a conduit for receiving the pliant reinforcing member, the conduit forming the void in the concrete element, the method comprising extending the pliant reinforcement member through the conduit.

Alternatively the void former is removable or partially removable and the method comprises removing the void former from the concrete element after the concrete element is set to form the void therein.

Alternatively the void former comprises a collapsible bag or membrane, and the method comprises collapsing the bag or membrane after the concrete element is set to form the void therein, or collapsing and removing the bag or membrane from the concrete element after the concrete element is set to form the void therein.

Alternatively the void former comprises a body formed of a material adapted to be dissolved, melted or otherwise destroyed, and the method comprises dissolving, melting or otherwise destroying the void former after the concrete element has set to create the void therein.

Optionally the void former comprises a removable weight for reducing buoyancy of the void former in wet concrete, the removable weight positioned to in use be adjacent an entrance or exit aperture of the void, and the method comprises removing the removable weight after the concrete element is set.

In another aspect, the present invention consists in a concrete element comprising at least one void former or at least one void each formed by a void former as described in one or more of the above statements.

In another aspect the present invention comprises a building or structure comprising at least one said concrete element, and one or more pliant reinforcing members extending through the void, a portion of the pliant reinforcing member extending outside the concrete element being anchored within the structure or building.

In another aspect, the present invention consists in a concrete element comprising a void formed by pouring and setting concrete around a void former, the void forming an aperture in a surface of the concrete element for at least one pliant reinforcing member to enter the void, the void adapted or shaped to direct the or each pliant reinforcing member through the void and back towards the surface of the concrete element to exit the void via the surface or substantially towards the direction it entered the void.

Preferably the void is in the shape of an arc or “U”, the aperture being an entrance aperture for the pliant reinforcing member to enter the void, and the void comprising an exit aperture in the surface of the concrete element for the pliant reinforcing member to exit the void, and a conduit with a substantially closed cross section between the entrance and exit apertures.

In another aspect, the present invention consists in a building or structure including at least one said concrete element, one or more pliant reinforcing members extending through the void, and a portion of the pliant reinforcing member extending outside the concrete element being anchored within the structure or building.

In one embodiments the pliant reinforcing member is arranged in at least one complete loop through the void, a portion of the loop extending outside the void.

In one embodiment the pliant reinforcing member extends through the void to form a double loop, a portion of the double loop extending outside the concrete element for anchoring within the structure or building.

In one embodiment, the pliant reinforcing member extends through a second void in an opposing concrete element. Preferably the pliant reinforcing member after extending through the second void extends through the first void to form at least one loop through the two voids.

In one embodiment the pliant reinforcing member forms a figure-of-eight loop.

Preferably there is a cavity or space between the concrete element and the opposing concrete element.

Preferably ends of the pliant reinforcing member are clamped to the loop of the pliant reinforcing member at a portion of the loop formed by the pliant reinforcing member within the cavity or space. Preferably the space or cavity is filled with concrete after the pliant reinforcing member has been extended though the two void formers to be embedded in the concrete in the space or cavity. The voids are filled with concrete to embed the pliant reinforcing member in the concrete element and the opposed concrete element.

In one embodiment, the concrete element comprises a plurality of said voids, at least one pliant reinforcing member extending through the plurality of voids, wherein at least one end of said member and a section of the pliant reinforcing member extending between two said voids is embedded in concrete of the concrete structure.

In one embodiment the pliant reinforcing member is formed in a serpentine shape through the plurality of voids, spaced apart intermediate portions of the pliant reinforcing member extending outside the concrete element between said voids for anchoring within the structure or building.

Preferably the void is filled with a suitable filler material such as a concrete material.

Preferably the pliant reinforcing member is not strained during construction to cause elastic elongation of the pliant reinforcing member.

In one embodiment an intermediate portion of the pliant reinforcing member extends outside the concrete element, and the structure or building comprises a transverse reinforcing member extending between the concrete element and the intermediate portion of the pliant reinforcing member, the intermediate portion of the pliant reinforcing member and the transverse member being embedded in poured in place concrete of the structure or building.

In one embodiment an intermediate portion of the pliant reinforcing member extends outside the concrete element, and the structure or building comprises a hook reinforcing member, the intermediate portion of the pliant reinforcing member passing through a bight of the hook reinforcing member, the intermediate portion of the pliant reinforcing member and the hook reinforcing member being embedded in poured in place concrete of the structure or building.

In one embodiment a pin is provided through the portion of the pliant reinforcing member extending outside the concrete element, the portion of the pliant reinforcing member and the pin embedded in poured in place concrete of the structure or building.

In one embodiment the portion of the pliant reinforcing member extending outside the concrete element comprises an end of the pliant reinforcing member, and the strands or the plurality of steel wires of the strands are spread or splayed apart and embedded in poured in place concrete of the structure or building.

In one embodiment the structure or building comprises a second concrete element comprising an elongate hollow chamber, an end of the pliant reinforcing member extending outside the concrete element being received in the elongate hollow chamber, and the elongate hollow chamber being filled with a cementitious material to embed the portion of the pliant reinforcing member in the second concrete element.

In one embodiment two ends of he pliant reinforcing member extend outside the concrete element, and the second concrete element comprising two elongate hollow chambers, each end of the pliant reinforcing member being received in one of the two elongate hollow chambers, and each elongate hollow chamber being filled with a cementitious material to embed the ends of the pliant reinforcing member in the second concrete element.

In another aspect the present invention comprises a construction comprising:

at least one panel precast from concrete,

a non-linear void in the panel having a first major opening in a surface of the panel and a second major opening in the surface of the panel, a primary passage following a non-linear path between the first major opening and the second major opening;

a pliant elongate reinforcing member extending completely through both major openings and the primary passage, poured in place concrete capturing portions of the pliant elongate reinforcing member outside the precast concrete panel, and

concrete at least partially filling the primary passage and capturing a portion of the pliant elongate reinforcing member located within the primary passage.

Preferably after exiting the void via the second major opening the pliant reinforcing member extends through the first major opening and through the second mayor opening to form at least one loop through the void.

In one embodiment, the panel comprises a plurality of voids, at least one pliant reinforcing member extending through the plurality of voids.

In another aspect the present invention consists in a void former for forming a void in a concrete element for receiving at least one pliant reinforcing member, the void former comprising;

a hollow member or assembly for receiving the pliant reinforcing member, the interior of the hollow member for forming the void in the concrete element,
an internal surface for directing the pliant reinforcing member through the void and back towards the surface of the concrete element to exit the void at the surface and at a distance away from a portion of the pliant reinforcing member entering the void,

Preferably the void former is shaped or configured to form a tube-like void or conduit in the concrete element having an entrance aperture and an exit aperture in a surface of the concrete element.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

It is to be understood that the term ‘engage further reinforcing member’ may mean touching or placed within the volume of a pull-out cone formed in the concrete when the pliant member is loaded in tension.

Further aspects of the present invention may become apparent from the following description given by way of example only and with reference to the accompanying drawings.

### BRIEF DESCRIPTION OF THE DRAWINGS

FIG. 1 shows a schematic representation of a cross-sectional vie of void former within a concrete element.

FIG. 2A is a perspective view of a component for a void former according to one embodiment.

FIG. 2B is a view from location D in FIG. 2A of the component of FIG. 4A.

FIG. 2C is a view from location E in FIG. 2A of the void former component of FIG. 4A,

FIG. 2D is an enlarged detail of region G of FIG. 2C.

FIG. 3A is a perspective view of a void former assembled from a pair of components according to FIG. 2A and a third connector component in one configuration.

FIG. 3B is a side view of the void former of FIG. 3A.

FIG. 3C is a top view of the void former of FIG. 3A.

FIG. 4A is a schematic cross-section of a concrete component including a void former according to FIG. 3 embedded with the ends at or above the surface.

FIG. 4B is a schematic cross-section of a concrete component incorporating an alternative void former assembly.

FIG. 4C is a schematic of a void former assembly similar to that in FIG. 4B, not showing the concrete component, but showing ends trimmed to reveal the formed cavity, and illustrating assembled grout conduits and flexible reinforcing element.

FIG. 5A is a schematic cross-section of a concrete component including a void former, illustrated from both the side and an end. A flexible reinforcing element is illustrated in both views to show the manner in which the reinforcing element passes through the void former.

FIG. 5B illustrates similar cross-sections to FIG. 5A, but illustrating the flexible reinforcing former in a complete loop.

FIG. 5C illustrates a similar void former arrangement to FIGS. 5A and 5B but with the flexible reinforcing forming a double loop.

FIG. 5D is a schematic cross-section of a concrete component incorporating multiple void forming assemblies and showing how a single flexible reinforcing element may pass through multiple void former cavities, including optionally forming one or more loops.

FIG. 6A illustrates a join portion between two concrete components wherein one of the components includes multiple void formers according to the present invention and wherein flexible reinforcing elements pass through each void former and have portions thereof located in a poured in place concrete component.

FIG. 6B similarly illustrates two joined concrete components, with one void former in an alternate arrangement to the arrangement in FIG. 6A.

FIG. 6C illustrates a third variation, with one of the concrete components including void formers oriented similar to FIG. 6B, but with the flexible reinforcing elements through each void former formed in loops.

FIG. 7A illustrates another connection between concrete components, where one of the components incorporates a void former at one edge or end. This schematic illustrates the presence of additional reinforcing in the component incorporating the void former and illustrates the interleaving of the reinforcement in the other concrete component with the flexible reinforcing that passes through the void former.

FIG. 7B illustrates a similar connection to the connection in FIG. 7A, but the void formers of FIG. 7B are oriented horizontally.

FIG. 7C illustrates a connection between multiple concrete components, wherein multiple of the concrete components include void formers, and wherein all of the concrete components are connected mutually by one or more flexible reinforcing loops,

FIG. 8A is a schematic illustrating protruding loops and ends of a flexible reinforcing loop and the manner in which this may be entwined with reinforcing arranged for a concrete component to be subsequently poured in place.

FIG. 8B is a schematic illustrating a concrete component with flexible reinforcing loops extending from it and arranged to be embedded in a subsequent component to be formed in place. The void formers carrying the flexible reinforcing through the illustrated concrete component are not shown.

FIG. 8C is a schematic illustrating a concrete component with flexible reinforcing loops extending from it and arranged to be embedded in a subsequent component to be formed in place. The void formers carrying the flexible reinforcing through the illustrated concrete component are not shown.

FIG. 9 is a partial cutaway schematic of a component sandwich panel including a void former in one concrete layer of the panel and flexible reinforcing extending through other layers of the panel.

FIG. 10 is a schematic illustrating of two precast concrete elements being brought together so as to insert a protruding pliant reinforcing member's end portions into a pipes of a lower element. An upper element includes a void formed by a void former including grout filling pipes.

### BRIEF DESCRIPTION OF PREFERRED EMBODIMENTS OF THE INVENTION

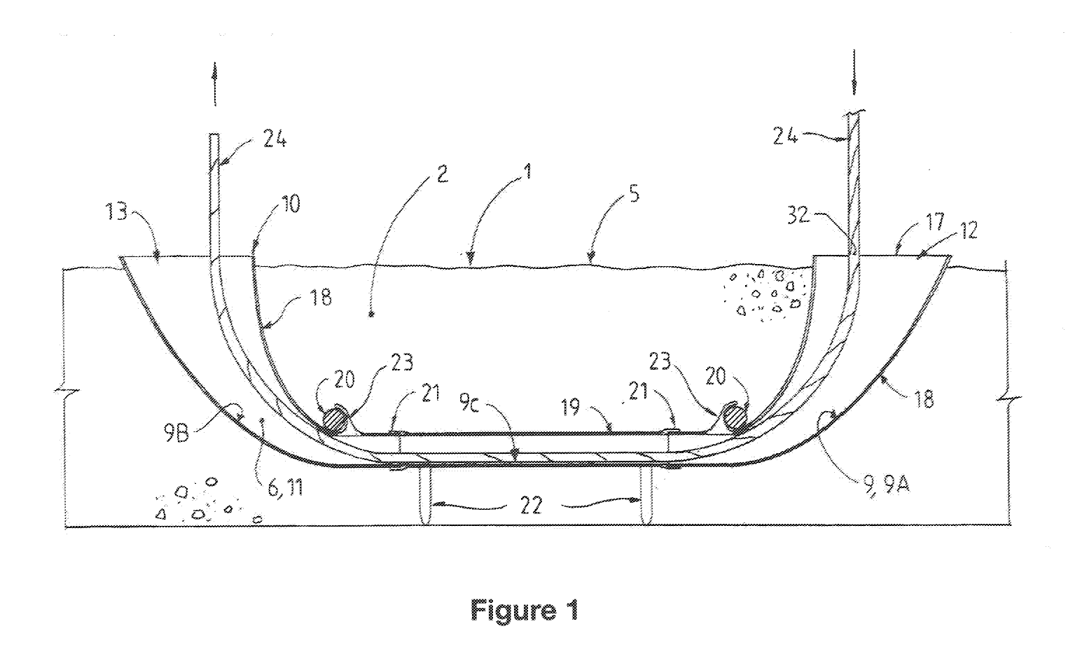

Referring first to FIG. 1 of the accompanying drawings, a cross-sectional view of a reinforced concrete element is shown generally by arrow 1. Concrete element 1 includes a void former 10. In the embodiment illustrated in FIG. 1 the void former is hollow and includes entry and exit receptacles 18 and a central pipe portion 19 in an interlocking relationship. The void former of the embodiment of FIG. 1 may be described as a U-shaped former. The void former is embedded in a concrete substrate 2 thereby creating a void 11 in the concrete element with an aperture 12 in the surface of concrete element 1.

The void former provides a void 11 or cavity in a concrete element, for example a concrete panel, for receiving a pliant reinforcing member 24 via the aperture 12. In the embodiment of FIG. 1, the void former is hollow, an internal volume of the former providing the void 11 in the concrete element. The void former forms an entrance aperture 12 and an exit aperture 13 in the surface 5 of the concrete element. Preferably the void formed in the concrete element is formed as a tube like conduit having an entrance aperture and an exit aperture in the surface 5 of the concrete element 1. Alternatively, the void may comprise a single aperture or open void with a U shaped or curved bottom surface, the reinforcing member extending into and out of the void via the same aperture. For example, the void former may be shaped or configured to form a void having an elongate bowl shape.

The entry and exit receptacles 18 have a generally conical cross-section shown in FIG. 1, with a wider area at the ends of the void former than towards the central pipe portion 19. This allows some flexibility in the positioning of the reinforcing member 24. The reinforcing member is a pliable reinforcing member, for example a steel wire cable. Receptacles 18 provide a smooth curving interior or internal concave surface 9 to direct the pliable reinforcing member 24 around the bends of the U-shaped former. The concave internal surface 9 assists insertion of the pliant reinforcing member as it is threaded or pushed through the void by a user (for example a construction worker or builder), for example in the direction of the arrows in FIG. 1. An end of the pliant reinforcing member contacts the concave internal surface as the member is pushed through the void by a user to direct the member through the void and back towards the surface 5 to exit the void at the surface 5 and at a distance away from a portion 32 of the pliant reinforcing member entering the void. Preferably the concave surface is shaped to direct the pliant reinforcing member through an obtuse angle relative to a central portion of the void as illustrated in FIG. 1. The concave internal surface is commensurate with the flexibility of the pliant reinforcing member so as to allow the pliant reinforcing member to be pushed or threaded through the void by a user pushing the pliant reinforcing member along a longitudinal axis of the pliant reinforcing member into the void via the entrance aperture so that contact between the pliant reinforcing member and the internal concave surface bends the pliant reinforcing member through the void and back towards the surface of the concrete element relatively easily, for example without plastic deformation of the pliant reinforcing member. In one embodiment as illustrated in FIG. 1. The concave surface of the void comprises a first curved surface 9A, a second curved surface 9B facing the first curved surface and spaced from the first curved surface by a connecting surface 9C. In an alternative embodiment, one or each surface 9A and 9B comprises a linear surface arranged at an obtuse angle relative to a central portion 9C of the void.

Receptacles 18 are joined through a tube or pipe 19 through which reinforcing member 24 may be threaded (for example pushed through), the join between receptacles 18 and pipe 19 being adapted to provide a substantially smooth inner surface to prevent impeding the movement of the end of reinforcing member through the void former. The end 21 of pipe 19 may be widened to fit around the end of receptacle 18 for this purpose. Alternatively the end of the receptacle 18 may be widened to fit over the pipe 19.

It will be appreciated that the general shape of the aperture formed by the void former may be of any shape allowing reinforcing member 24 to be threaded through it and generally directing the reinforcing member back towards the direction it entered the void former so both ends of the reinforcing member exit a concrete element on the same surface 5 of the concrete element. The extent to which the reinforcing member is bent back towards itself will depend on the particular application and where and how the ends of the reinforcing member extending from the concrete element are to be anchored. For example different lengths of the central pipe 19 may be provided so that different length voids can be provided. The longer the central pipe portion, the longer the length of reinforcing is located in the concrete element increasing the holding capacity of the reinforcing member.

The void former may include one or more protrusions or legs 22, which position the void former from a surface in use. The legs 22 may position the void former during pouring of the concrete substrate 2, thereby ensuring the void former is located at the required depth in the substrate 2,

The void former may comprise one or more hooks 23. One or more internal reinforcing members 20 for the concrete substrate 2 may be held in the hooks 23. Internal reinforcing 20 is placed on the void former prior to the pouring of concrete and hooks 23 hold the reinforcing in place during pouring. In use the reinforcing 20 acts as a pivot point to the loaded pliable reinforcing 24, so as to redistribute load back into substrate 2. It will be appreciated that any receiving means adapted to hold internal reinforcing member in place may be substituted for hooks 23 including a pair of inwards facing hooks, an aperture in the external surface of the void former, one or more clips, one or more markings, raised portions, recessed portions, or some other receptacle or locating means formed part of or separate to the void former.

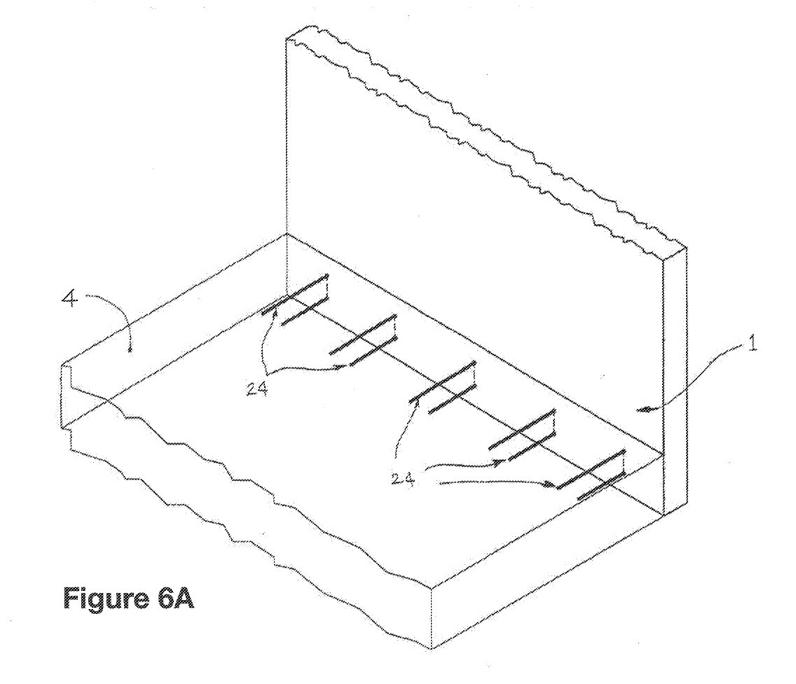

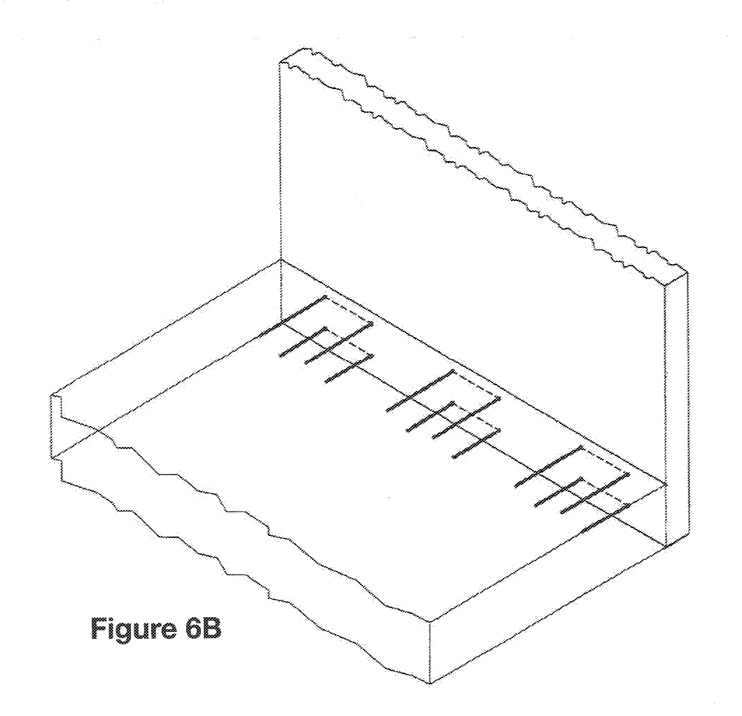

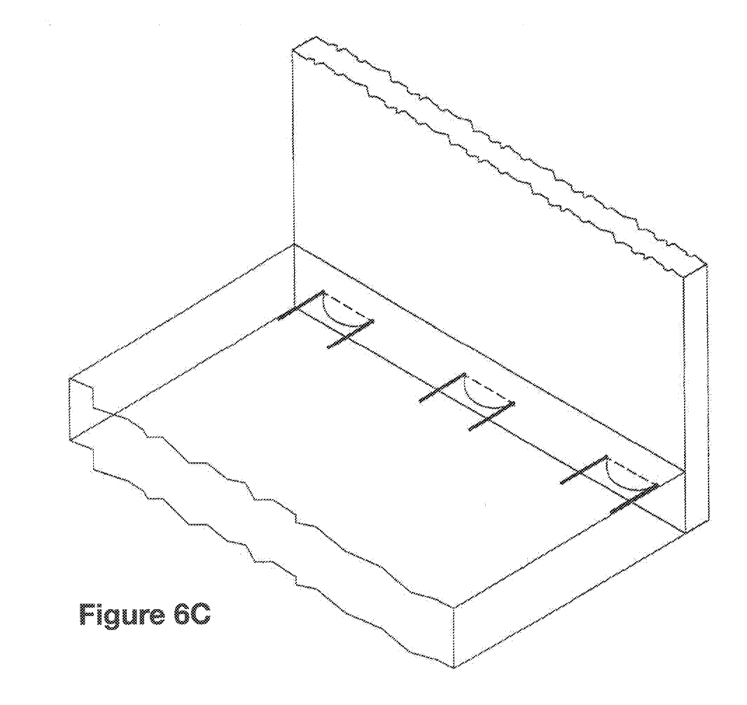

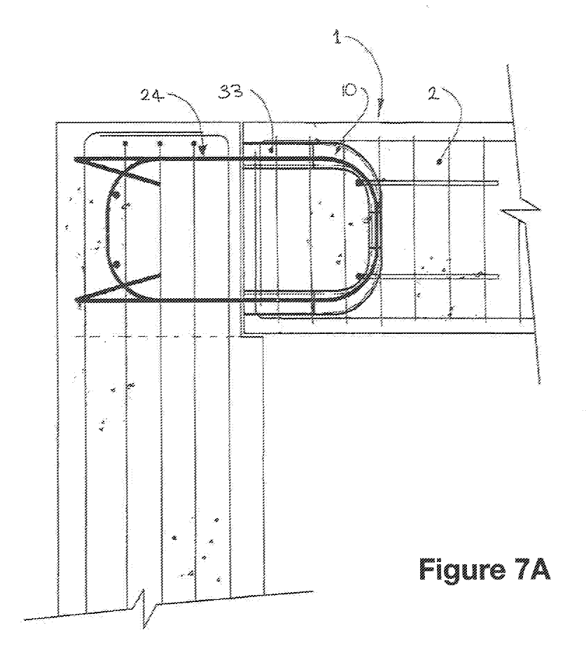

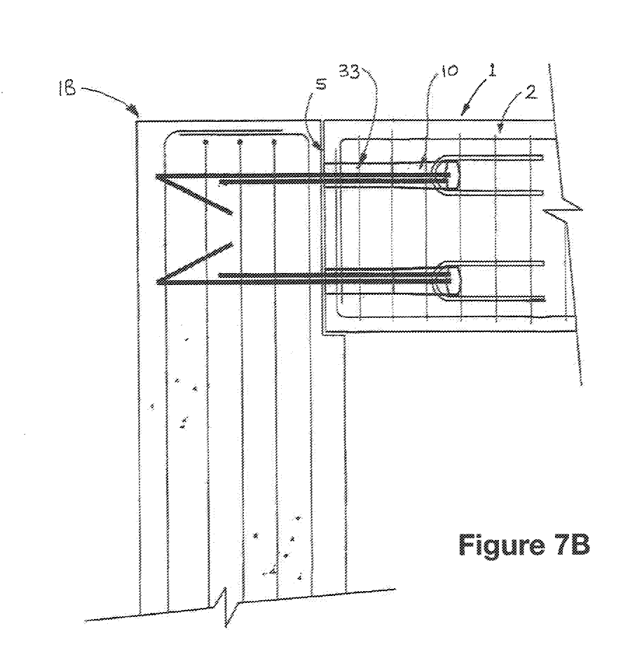

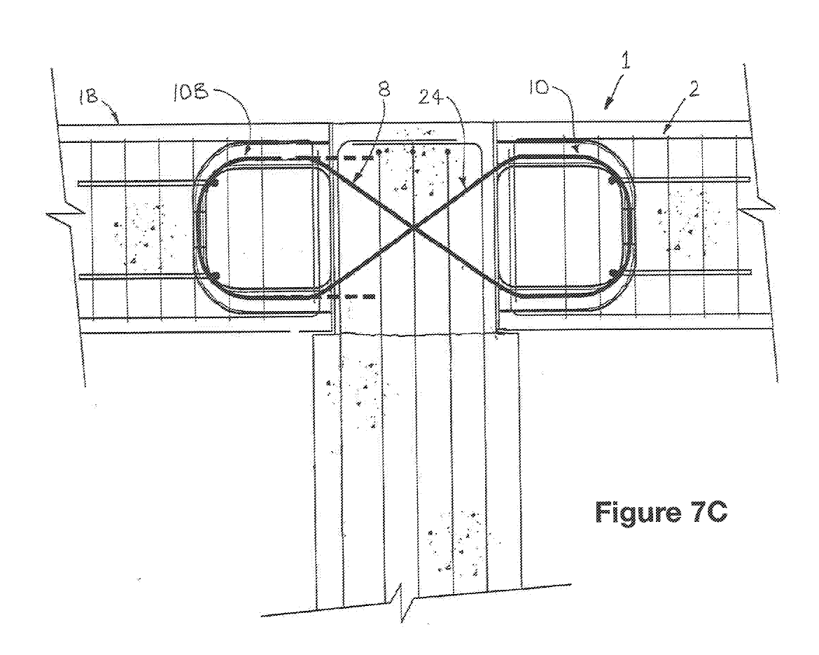

A pliable reinforcing member 24 is threaded through the void former and the ends of reinforcing member 24 are anchored, for example by embedding the ends in a structure such as a concrete floor 4 that is poured in place, as shown in FIGS. 6A to 6C, or other supporting structure as shown in FIGS. 7A to 7C. The pliable reinforcing member 24 may be bent or splayed to ensure secure anchoring in concrete. Alternatively, an end of pliable reinforcing member 24 may be threaded through at least a second void former 10B in a second concrete element 1B, for example like the arrangement shown in FIG. 7C. The pliable reinforcing member may be arranged so that a loop 8 is formed between the first and second void former. For example, as shown in FIG. 7C, the loop 8 is formed in a space between the two concrete elements, and the space is subsequently filled with concrete to anchor the loop in the structure. In the illustrated arrangement in FIG. 7C, the loop is formed in a figure-of-eight. Preferably end portions of the pliant reinforcing member are clamped to a section of the pliant reinforcing member within the space between the two concrete elements so that movement of the reinforcing member is restricted or prevented when under load. The voids may be filled with concrete before or after the space between the two concrete elements is filled with concrete.

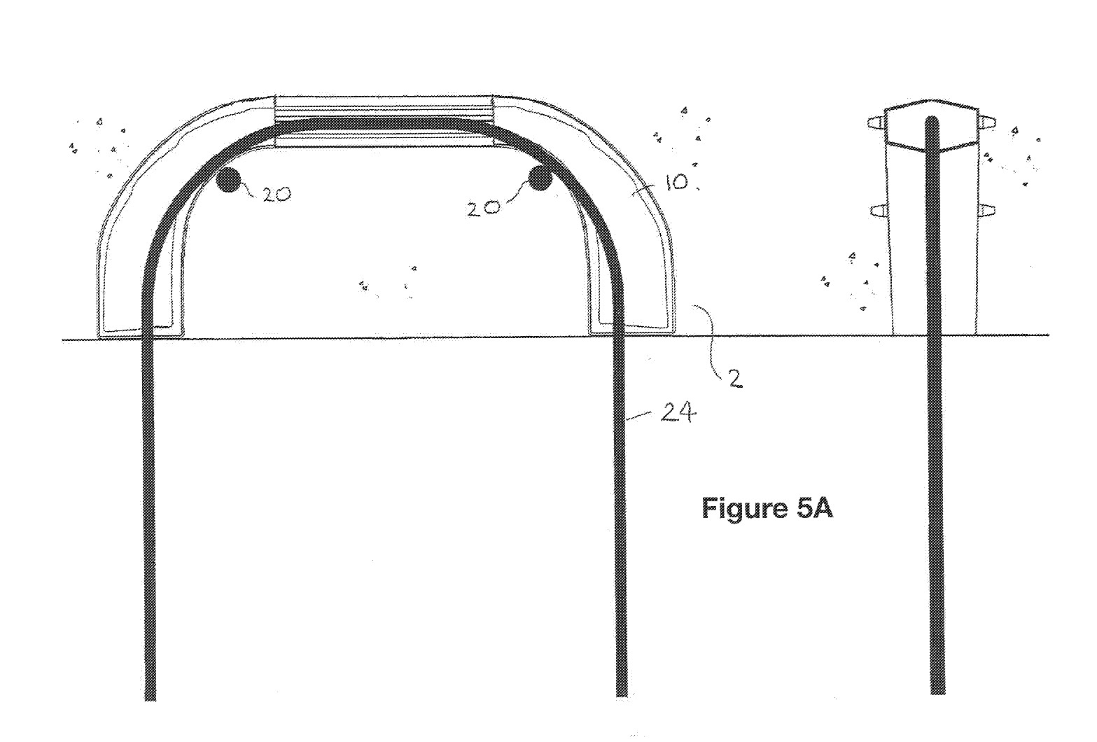

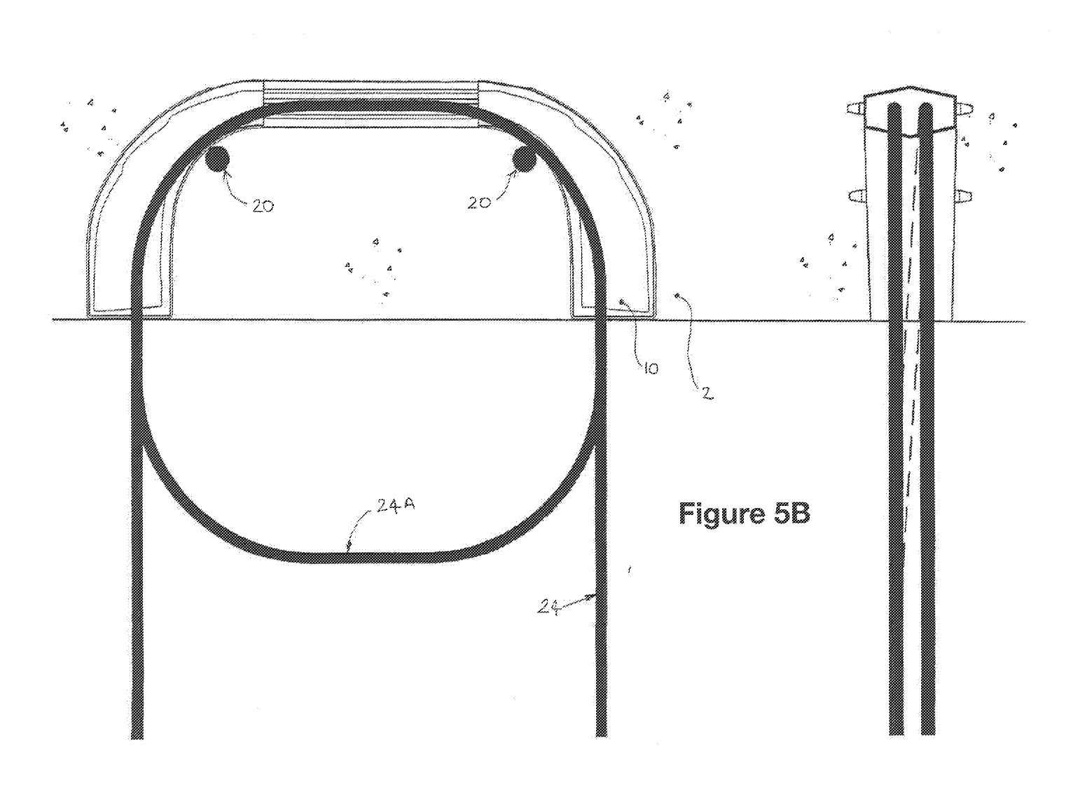

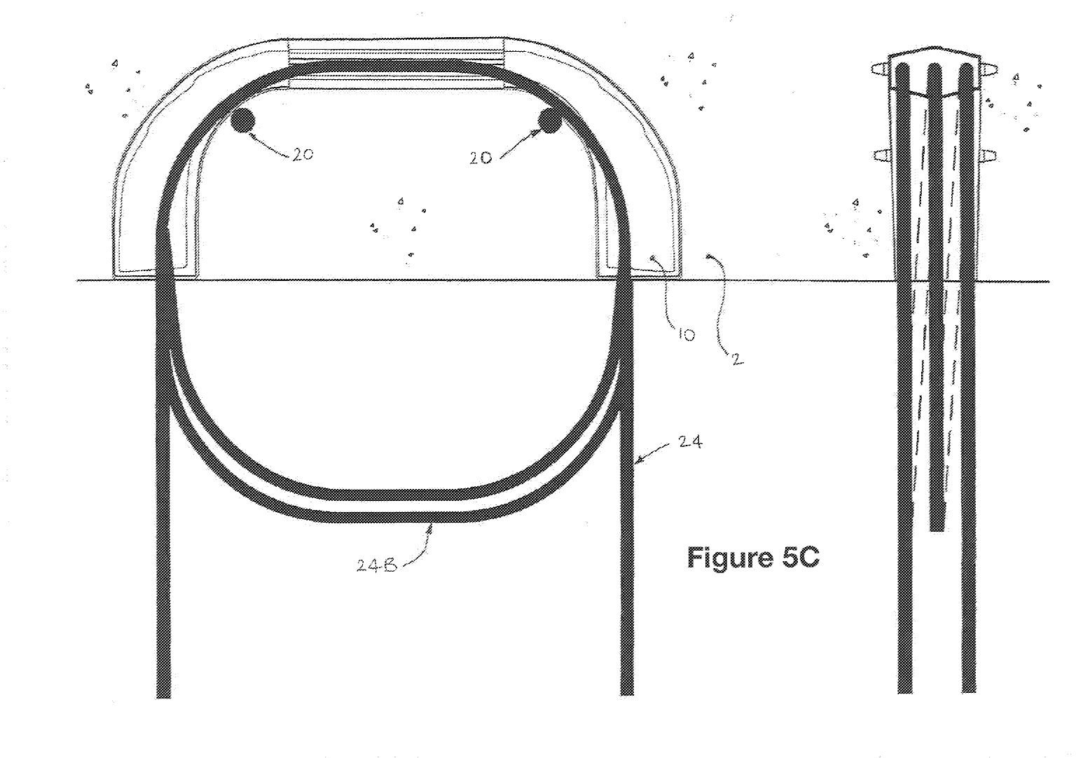

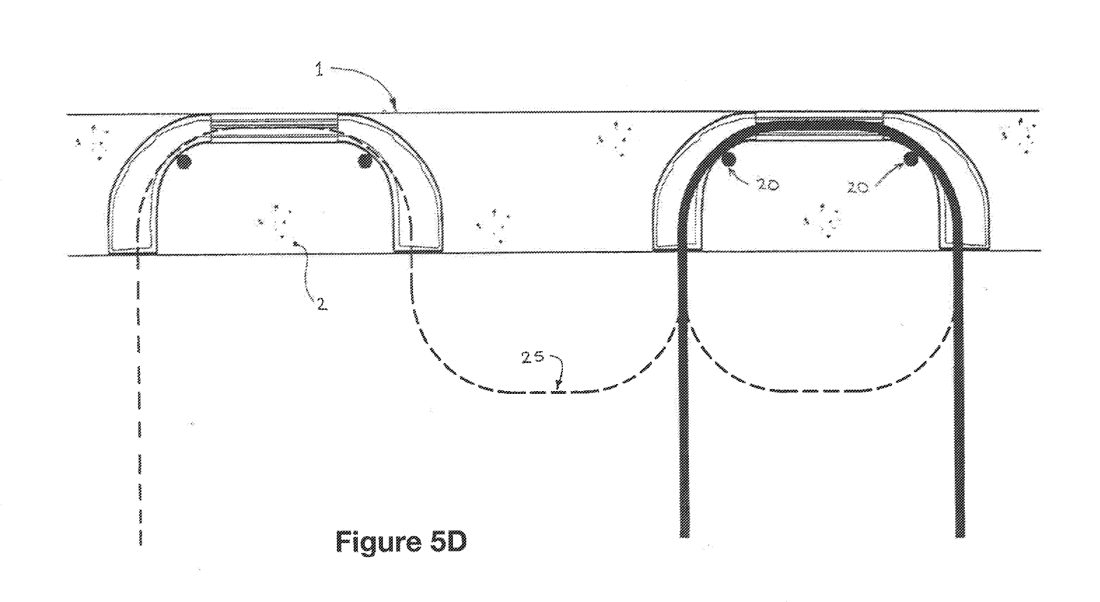

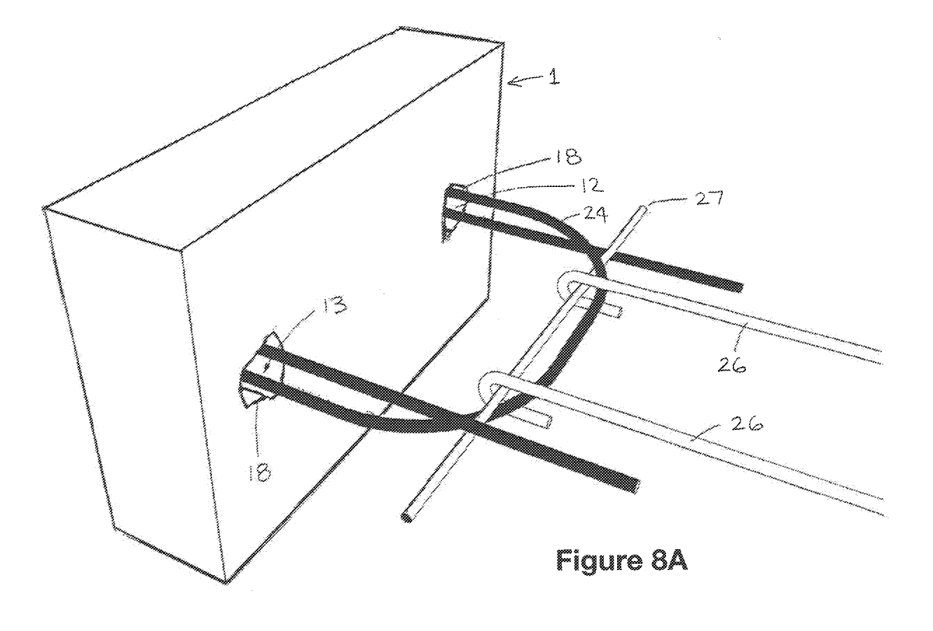

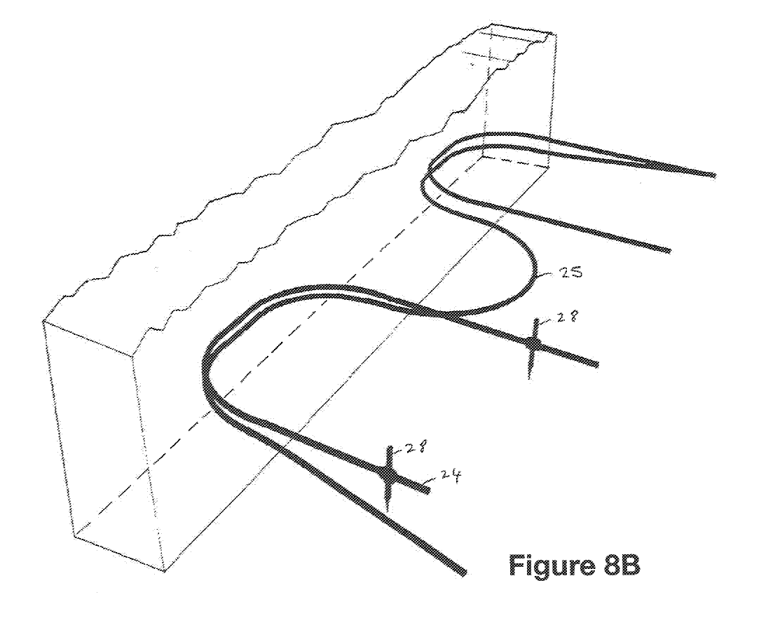

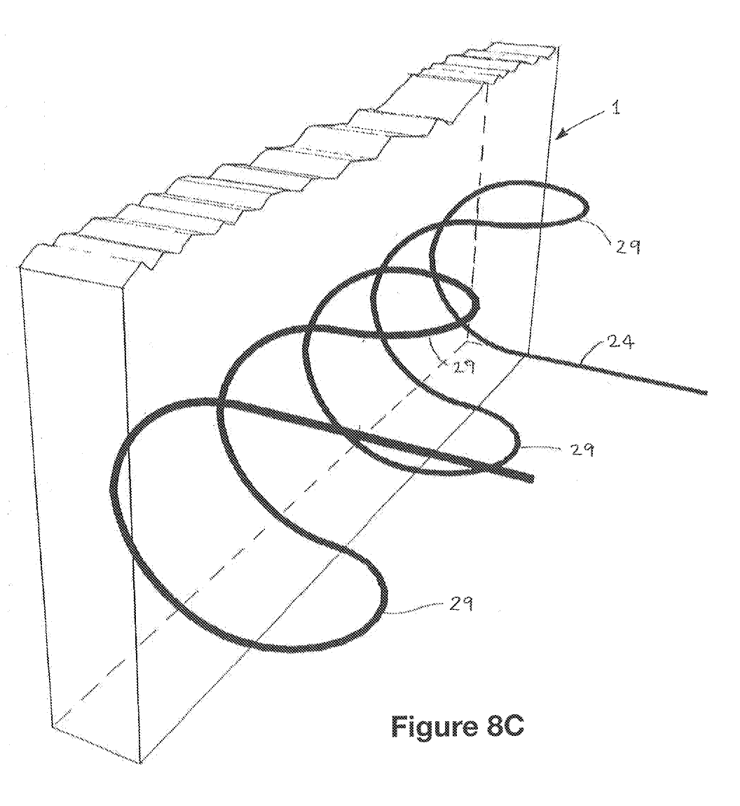

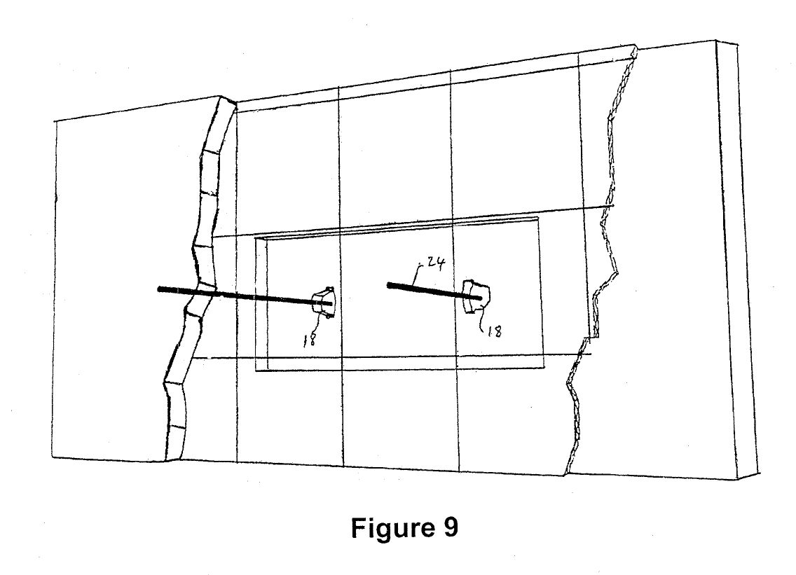

FIG. 5A illustrates a single pass of a reinforcing member 24 through the void former 10. FIG. 5B illustrates a void former 10 and a flexible reinforcing former in a complete loop 24A through the void former. FIG. 5C illustrates a similar void former arrangement to FIGS. 5A and 5B but with the flexible reinforcing forming a double loop 24B. FIG. 5D and FIG. 8B illustrates a concrete component 1 incorporating multiple void formers and showing how a single flexible reinforcing element 25 may pass through multiple voids, including optionally forming one or more loops. Reinforcing member 25 is threaded through multiple voids to form a serpentine shape, with sections of the pliant reinforcing member between voids extending or protruding from the concrete substrate 2. FIGS. 5D and 8B show a reinforcing member 25 extending through two voids to form a serpentine shape, however a reinforcing member 25 may extend through more than two voids to form a serpentine shape, a length of the reinforcing member between adjacent voids extended from the concrete element. It will be appreciated that a pliant reinforcing member can be inserted into the concrete element 1 at any time, for example before or after the concrete substrate has set.

The present invention allows a flexible reinforcing member to be inserted into the concrete element only when required, avoiding the risk of repeated bending of the reinforcing when the concrete element is placed and hence ensuring the reinforcing is not weakened by repeated bending. Furthermore, the flexible reinforcing member is easy to manhandle. Preferably the pliant reinforcing member is not strained to cause elastic elongation of the pliant reinforcing member during construction of a structure or building. For example, a construction worker lays or positions portions of a pliant reinforcing member extending from a concrete element in a space in which concrete is to be poured to anchor the portions of the reinforcing members in the building or structure.

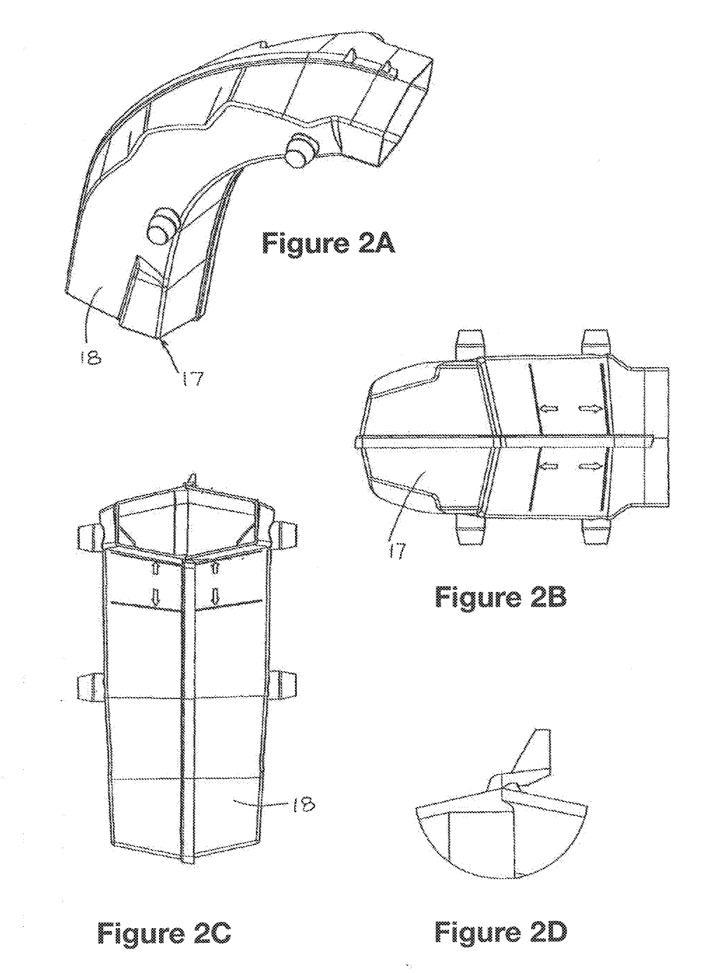

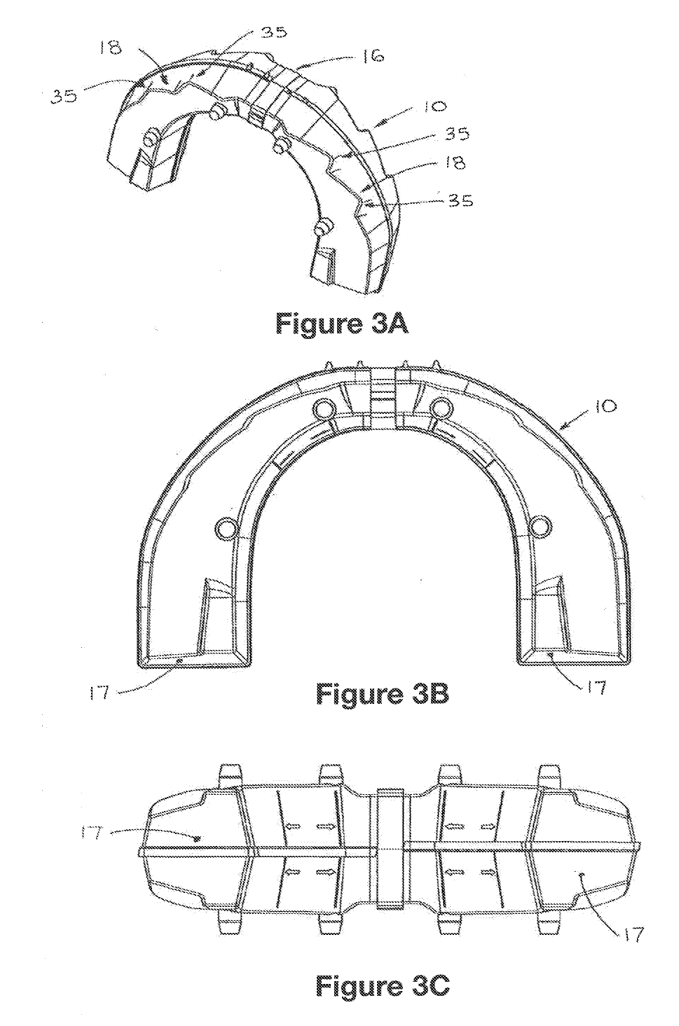

In the embodiment of FIG. 1 the void former is hollow, an internal volume of the void former forming the void 11 in the concrete element. In a preferred embodiment as shown in FIGS. 2A to 3C, the void former is hollow and includes surfaces 17 of receptacles 18 that prevent concrete or debris entering the void former. Each surface 17 may be removable or may be cut or broken through or off to allow access by reinforcing member 24 into the hollow void former. Once the void former is embedded in the concrete element, each surface 17 forms a cover over the entrance and exit apertures 12, 13 in the concrete element. In use, a user may break surfaces 17 to open the entrance and exit apertures in the concrete to provide access to the void in the concrete element. In one use of a hollow void former without openings, the void former may be positioned below the surface of the concrete element so that, after the concrete element has set, concrete between the surface 5 of the concrete element and the void former (for example surfaces 17) can be broken to create the entrance aperture or the entrance aperture and an exit aperture.

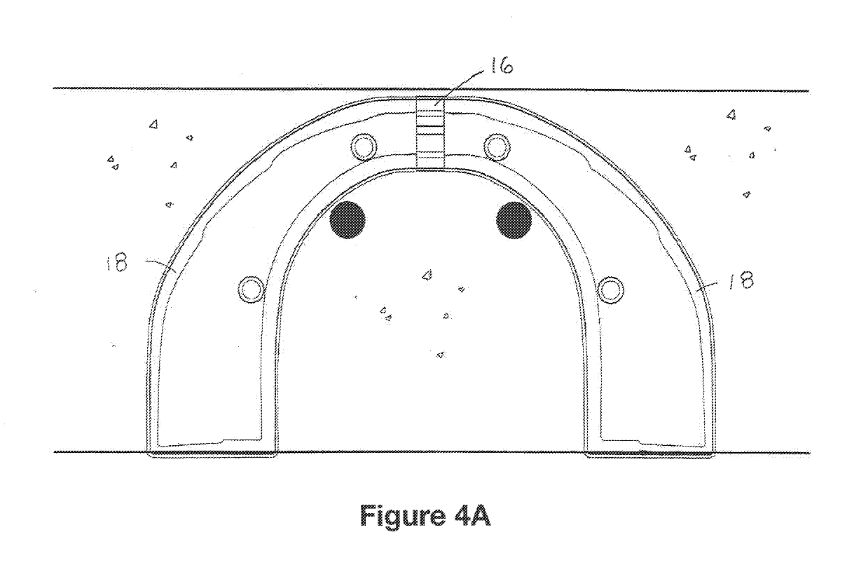

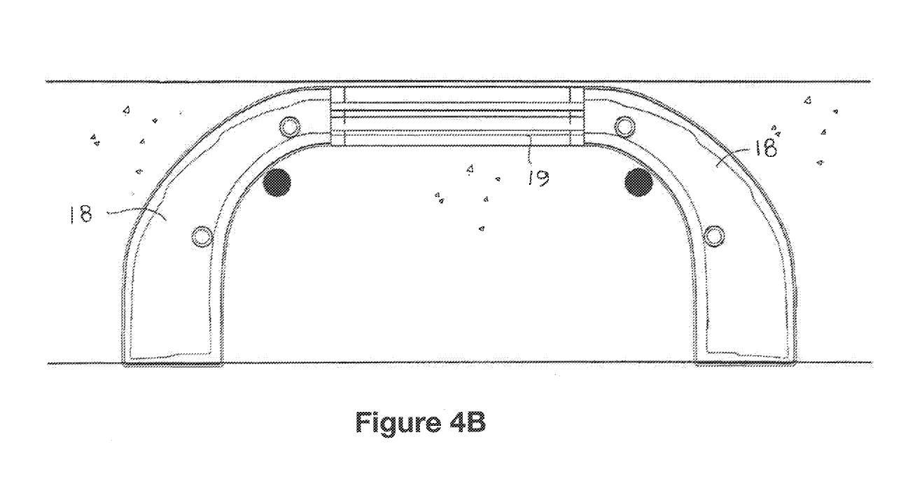

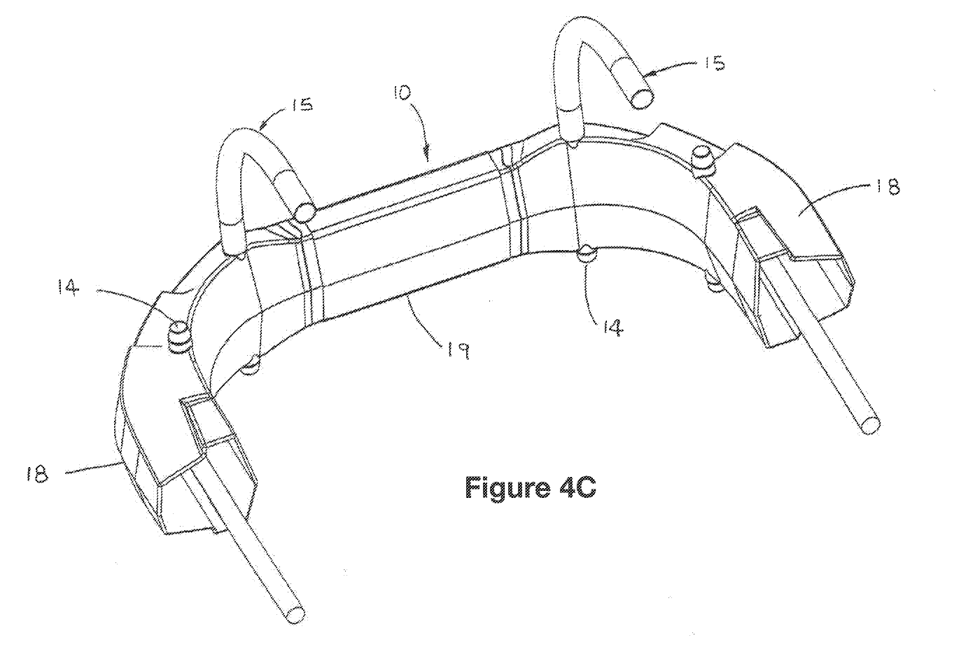

It will be appreciated that the shape of receptacle 18 and pipe 19 is not limited to those shown in the drawings and could form any required shape defining an cavity or void suitable for directing a pliable reinforcing member through the void former. An alternate embodiment to the schematic representation of FIG. 1 is illustrated in FIGS. 3A-4A. In this illustrated embodiment, two receptacle sections 18 are joined together to form a U-shaped void former having a shorter path between the two receptacles compared to the schematic representation of FIG. 1. In the embodiment of FIG. 3A, the two receptacles 18 are joined by a connector component 16. Connector 16 may form a short pipe section. Alternatively, the receptacles may comprise connection details such as clips allowing the two receptacles to be clipped or joined together without a connector component in between the receptacles 18. FIG. 4B illustrates a similar arrangement to the schematic of FIG. 1 wherein the void former comprises a pipe section between the spaced apart receptacles 18. This pipe section may be in two halves that clip together to form a pipe.

Receptacle 18 and pipe 19 may be constructed from any suitable material and is preferably constructed from a plastics material for receptacle 18 and 19 and aluminium or steel for pipe 19. It will be appreciated that the void former could be an integral unit, the receptacles and central pipe being integrally formed together, or may comprise a number of interconnecting parts, for example, as shown in FIG. 2A to 2D, a receptacle 18 is formed in two halves clipped together along a centreline of the receptacle. A suitable clipping arrangement for connecting the two halves is shown in FIG. 2D.

The void former, for example as shown in FIGS. 1 to 4C may be provided with extension members, for example extension members 33 as illustrated in FIGS. 7A-7C. Extension members 33 set a depth of the void former 10 below the surface 5 of the concrete element and form a portion of the void in the concrete. The extension members 33 may be hollow and assembled to the void former 10. Alternatively the extension members may be formed of a destroyable material, for example polystyrene, to be broken out of the void formed in the concrete after the concrete element has set.

As best shown in FIG. 3A, the hollow void former preferably has sloping surfaces 35. Sloping surfaces are surfaces formed in a curved back side of the former that are arranged at a slope or slant to the general curvature of the back side of the void former. The sloping surfaces increase the holding strength of the pliant reinforcing member once the void is filled with a suitable filler to embed the member in the concrete element. The curved back side of the former comprising sloping surfaces 35 may be described as having steps 35 in the surface of the void former. Alternatively, surfaces of the void former may comprise serrations to protrude into the surrounding concrete to increase the holding strength of the pliant reinforcing member when tensioned.

It will be appreciated that the void former may be filled with a suitable material to protect or anchor reinforcing member 24 after reinforcing member 24 is passed through the void former. For example, as shown in FIG. 4C, one or more grout conduits 15 may be provided. Grout conduits are provided prior to pouring the precast concrete element and are arranged to exit the surface 5 of the concrete element. Once a reinforcing member is installed through the void 10, grout or cementitious material may be added to the void. The grout or cementitious conduits allow air and excess grout or concrete to bleed from the void to assist with filling the void with grout or other filler material via the receptacle, or alternatively grout may be added to the void through one or more grout conduits. The grout conduits may be fitted over a projection on the void former. For example protrusions or legs 14 may be provided. An end of the protrusion may be closed; prior to fitting the grout conduit over the protrusion 14, the end of the protrusion is cut or opened.

As explained above, the pliable reinforcing member 24 may be bent or splayed for securement within a poured in place concrete component. Alternatively or in addition, reinforcing members may be provided to be embedded in a poured in place component. For example, FIG. 8A illustrates a pliable or flexible reinforcing member looped through a said void former embedded in a precast concrete component. The loop of the reinforcing member 24 is entwined with a reinforcing arrangement for a concrete component to be subsequently poured in place. The reinforcing arrangement comprises two U or hook shear members 26 and a transverse member 27. The reinforcing member 24 passes through the bight of the hook of the reinforcing members 26. The transverse member 27 passes through the loop of the reinforcing member 24.

FIGS. 8B and 8C illustrate alternative arrangements for embedding a pliant reinforcing member 24 in a poured in place concrete component. In FIG. 8B, the reinforcing member is additionally anchored using a steel pin 28 pushed through and between wires of the pliant reinforcing member so as to increase the reinforcing members diameter to increase its anchoring capacity. In FIG. 8C, the reinforcing member 24 is threaded through multiple void formers (not shown) in a precast element and the sections 29 of the reinforcing member between void formers and extending from the concrete element 1 are arranged to be embedded in a poured in place component. In the arrangement illustrated in FIG. 8C, void formers are positioned so that the entrance and exit apertures of each void are arranged vertically one above the other in the same way the voids are positioned in the arrangement illustrated in FIG. 6A.

Void formers according to the present invention may also be used in a composite element. For example, FIG. 9 shows a partial cutaway schematic of a component sandwich panel including a void former in one concrete layer of the panel and flexible reinforcing extending through other layers of the panel.

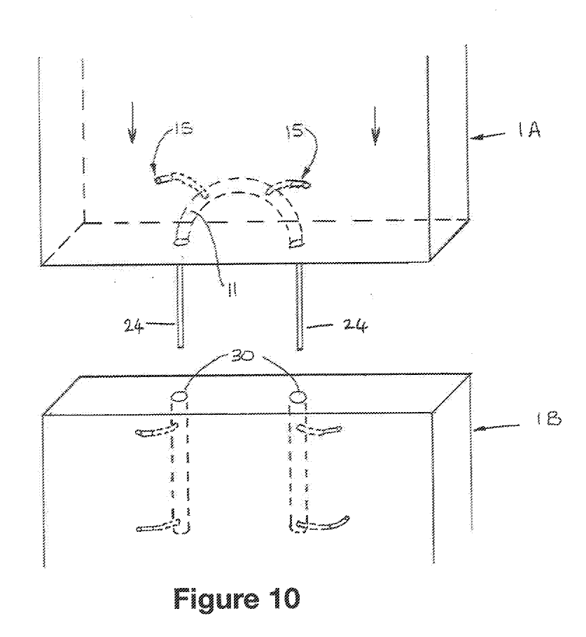

FIG. 10 illustrates an alternative arrangement where two precast concrete elements 1A, 1B are being brought together so as to insert the protruding pliant reinforcing member's 24 end portions into the hollow pipes or cavities 30 of the lower element 1B. The upper element 1A includes a void 11 formed by a void former including grout filling pipes 15. Once the two elements 1A, 1B are assembled together, the void 11 and cavities 30 are filled with concrete via the conduits 15 so as to surround the pliant reinforcing member,

There is thus provided a void former and a method of use thereof to reinforce a concrete element and a concrete structure, both internally and between separate concrete elements. The reinforcing member between concrete elements may be inserted only when required, avoiding the hazards and disadvantages of embedded reinforcing.

The void former illustrated in FIGS. 1 to 4C is hollow, an inside of the void former providing the void in the concrete element once the void former is embedded in the concrete element.

In an alternative embodiment, the void former is provided as a destroyable body, for example a solid body formed of a material such as body formed of a material adapted to be dissolved, melted or otherwise destroyed. The destroyable void former may take a similar shape to the illustrated hollow void former, for example a U shaped void former. To create a void in a concrete element using a destroyable void former, the void former is embedded in the concrete of the concrete element. After the concrete of the concrete element has set, the void former is destroyed for example broken out, melted or dissolved, to create the void. The external surfaces of the destroyable void former preferably are similar to the internal surfaces of the illustrated void former, so that the void left in the concrete element after the destroyable void former has been removed has surfaces similar to the internal surfaces of a hollow void former, such that the void in the concrete has an internal smooth concave surface for directing the pliant reinforcing member as it is threaded through the void.

In one embodiment, the destroyable void former is formed from polystyrene. The polystryrene may be broken out of the void, for example by a rigid bar pushed into the polystyrene embedded in the concrete. Alternatively a solvent may be poured onto the polystyrene to dissolve the former to leave the void in the concrete.

The void former may comprise a removable weight for reducing buoyancy of the void former in wet concrete. The removable weight is preferably positioned adjacent to an entrance or exit aperture (or both) of the void to be formed in the concrete element for easy removable after the concrete element has set.

In another embodiment, the void former is removable from the concrete element after the concrete element has set. For example, the void former comprises a collapsible bag or membrane. The bag or membrane is adapted to be deflated to be removed from the concrete element to form the void when the concrete element has set. In an inflated state, the bag or membrane may form a similar shape to the illustrated hollow void former, for example a U shaped void former. To create a void in a concrete element using a collapsible void former, the void former is embedded in the concrete of the concrete element. After the concrete of the concrete element has set, the void former is deflated and removed from the void, for example via an exit or entrance aperture. In the inflated state, the external surfaces of the collapsible void former preferably are similar to the internal surfaces of the illustrated void former, so that the void left in the concrete element after the void former has been removed has surfaces similar to the internal surfaces of a hollow void former, such that the void in the concrete has an internal smooth concave surface for directing the pliant reinforcing member as it is threaded through the void

Preferably the flexible reinforcing member comprises a flexible multiple strand cable. Preferably the cable is flexible enough so that a user holding a length of approximately 500mm of the cable in one hand can bend the length in one plane with the user's other hand by approximately 180 degrees without plastic deformation of the cable and rigid enough to be pushed by hand in the direction of the longitudinal axis of the cable (for example along the direction of the arrows in FIG. 1) through a void defined by a concave surface.

To achieve the necessary flexibility for easy handling by a user, preferably the cable comprises a plurality of strands helically wound around a core defining the centre of the cable. Each strand comprises a plurality of helically wound wires wound around a core defining the centre of the plurality of wires. The core of a strand may be a single wire. Alternatively the core of a strand is weaker than a said wire, for example the core is a natural or synthetic fibre. The core of the cable may be a strand, or may be weaker than a strand, for example the core of the cable may be formed from a natural or synthetic fibre. In one embodiment, the cable comprises more than one layer of helically wound strands. Preferably the wires of the cable are steel wires.

When the preferred pliant reinforcing member is embedded in cementitious material, helical groves formed on the outside of the cable between the helically wounds strands are filled with concrete of the concrete element to bond the cable with the concrete to resist pullout strengths when loaded.

Preferably the pliant reinforcing member comprises an identifier for easy recognition, for example so that a user or an inspector may verify reinforcing of the correct strength is used in reinforcing a structure. The identifier is preferably laid along the length of the pliant reinforcing member, the identifier comprising one or more of a tape, a thread that is colour or named, indentations to form a pattern on wire a wire painted or coloured.

Preferably the pliant reinforcing member is flexible and pliant enough so that it can be easily manhandled for inserting through a void or for laying or positioning portions of a member extending from a concrete element within a cavity or space or other volume to be filled with concrete, for example poured in place concrete. Preferably the pliant reinforcing member comprises wires that are arranged so that under tension there is an initial stretch in the pliant reinforcing member before elastic stretch of the wires, for example an initial stretch of about 0.05-10% elongation.

Where in the foregoing description, reference has been made to specific components or integers of the invention having known equivalents then such equivalents are herein incorporated as if individually set forth,

Although this invention has been described by way of example and with reference to possible embodiments thereof, it is to be understood that modifications or improvements may be made thereto without departing from the scope of the invention.

1. A void former for forming a void in a concrete element for receiving at least one pliant reinforcing member, the void former shaped or configured so that the void formed by said void former comprises:
an aperture in a surface of the concrete element for a said pliant reinforcing member to at least enter the void,
an internal surface shaped to direct the pliant reinforcing member through the void and back towards the surface of the concrete element to exit the void at the surface of the concrete element at a distance away from a portion of the pliant reinforcing member entering the void.

2. A void former as claimed in claim 1 wherein the void former is in the shape of an arc or “U”.

3. A void former as claimed in claim 1 wherein the aperture is an entrance aperture in the surface of the concrete element and the void former shaped or configured so that the void formed by said void former comprises:
an exit aperture in the surface of the concrete element for the pliant reinforcing member to exit the void, and
a tube-like conduit extending between the entrance aperture and the exit aperture.

4. A void former as claimed in claim 1 wherein the internal surface is shaped to facilitate insertion of the pliant reinforcing member through the void by having a shape that directs the pliant reinforcing member through an obtuse angle relative to a central portion of the void.

5. A void former as claimed in claim 3 wherein the void former is shaped so that the cross sectional area of the void increases towards the entrance and exit apertures from a central portion of the void.

6. A void former as claimed in claim 1 including one or more protrusions or legs extending from the exterior surface of the void former, the protrusions or legs being adapted to raise the void former from an opposite surface of the concrete element so that the void former can be substantially surrounded by the concrete of the concrete element.

7. A void former as claimed in claim 1 including one or a plurality of pipes protruding from the surface of said void former or one or a plurality of protrusions protruding from the surface of said void former, each protrusion for attaching a pipe, said pipe or pipes adapted to extend to above the surface of the concrete element so that cementitious materials can flow through the pipes to fill the void.

8. A void former as claimed in claim 1 wherein the void former comprises an entrance part, an exit part, and a spacer between the entrance and exit parts, the length of the spacer predetermined for a desired loading capacity of the pliant reinforcing member.

9. A void former as claimed in claim 1 wherein the void former is constructed to remain or at least remain partially in the concrete element after the concrete element has set, the void former comprising a hollow member or assembly for receiving the pliant reinforcing member, the interior of the hollow member forming the void in the concrete element.

10. A void former as claimed in claim 1 wherein the void former is adapted to be held in an engaging arrangement against at least a further reinforcing member on or near an exterior surface of the void former.

11. Avoid former as claimed in claim 10 wherein the void former comprises a further reinforcing member locating means adapted to position the further reinforcing member on or near an exterior surface of the void former.

12. Avoid former as claimed in claim 1 wherein the pliant reinforcing member comprises a multiple strand cable, each strand comprising a plurality of steel wires.

13. A method of reinforcing a concrete structure including:
providing a void former for forming a void in a concrete element with an aperture in a surface of the concrete element,
setting concrete around the void former to form a precast concrete element comprising the void; the void former shaped or configured so that the void formed by said void former comprises the aperture in the surface of the concrete element for a pliant reinforcing member to enter the void, and an internal surface shaped to direct the pliant reinforcing member through the void and back towards the surface of the concrete element to exit the void at the surface of the concrete element at a distance away from a portion of the pliant reinforcing member entering the void;
inserting a pliant reinforcing member into the void so that at least one end portion of the pliant reinforcing member protrudes from the surface;
anchoring at least one end portion of the pliant reinforcing member in the concrete structure.

14. A method as claimed in claim 13 comprising:
threading the pliant reinforcing member through more than one said void in the concrete element, each void formed by a said void former, and anchoring at least one end portion and a portion of the pliant reinforcing member extending between voids in the concrete structure.

15. A method as claimed in claim 13 comprising turning the pliant reinforcing member at least once back through the aperture to re-enter the void so that the pliant reinforcing member forms a loop, a portion of the loop extending beyond the surface of the concrete element, and anchoring the portion of the loop in the concrete structure.

16. A method as claimed in claims 13 comprising providing a suitable void filling material installed through pipes protruding from the void former and extending beyond the surface of the concrete element to hold and protect the pliant reinforcing member when in use.

17. A method as claimed in claim 13 comprising anchoring at least one end portion of the pliant reinforcing member in a second precast concrete element in which at least one elongate hollow chamber is formed for receiving an end portion of the pliant reinforcing member, bringing the precast elements together, filling the elongate hollow chamber and the void with concrete to embed the pliant reinforcing member therein.

18. A method as claimed in claim 13 comprising positioning the precast element adjacent to a second precast element, each precast element having at least one void formed by a said void former, leaving a space between the two precast elements, extending the pliant reinforcing member through the void of each precast element to form at least one loop through said void formers, and filling the space between the two precast elements with concrete to embed the pliant reinforcing member between the two precast elements.

19. A concrete element comprising at least one void former o at least one void each formed by a void former as claimed in claim 1.

20. A building or structure comprising at least one concrete element as claimed in claim 19, and one or more pliant reinforcing members extending through the void, a portion of the pliant reinforcing member extending outside the concrete element being anchored within the structure or building.
